(19) United States
(12) Patent Application Publication
(10) Pub. No.: US 2007/0266813 A1
(43) Pub. Date: Nov. 22, 2007

(54) XY STAGE

(75) Inventor: Yoshinao NAITO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 11/750,001

(22) Filed: May 17, 2007

(30) Foreign Application Priority Data
May 18, 2006 (JP) 2006-139084

(51) Int. Cl. G05G 9/047

(52) U.S. Cl. 74/471 XY

(57) ABSTRACT

Disclosed is an XY stage comprising a moving table, a first guide mechanism to guide the moving table in a predetermined direction, a moving body mounted to the moving table, a second guide mechanism to guide the moving body in a direction intersecting with a guiding direction of the first guide mechanism with respect to the moving table, a drive mechanism to drive the moving table in the guiding direction of the first guide mechanism, and a converting mechanism to convert motion of the moving table in the guiding direction of the first guide mechanism into motion of the moving body in a guiding direction of the second guide mechanism.

### BACKGROUND OF THE INVENTION

1. Field of the Invention

The present invention relates to an XY stage to determine a two dimensional position of an embarkation or the like.

2. Description of the Related Art

A typical XY stage determines a two dimensional position of an embarkation using two motors (confer Japanese Patent Publication No. 7-123135 for example), and an XY stage 501 shown in FIG. 5 is such a typical XY stage. As shown in FIG. 5, an X-table 503 is guided in the X direction by X direction shafts 511 and 512, and the X-table 503 is driven in the X direction by a motor 533 and a belt transmission mechanism 532. A Y-table 505 is mounted on the X-table 503, the Y-table 505 is guided in the Y direction by the Y direction shafts 521 and 522, and the Y-table 505 is driven in the Y direction by a motor 591 and a belt transmission mechanism 592. A cable 593 is connected to the motor 591, and the motor 591 is driven through the cable 593. The Y direction shafts 521 and 522, the motor 591 and the belt transmission mechanism 592 are mounted on the X-table 503, and are moved in the X direction together with the X-table 503.

However, to protect the cable 593, the cable 593 must have flection-resistant properties, and a conduit through which the cable 593 passes must also be flexible. Thus, the XY stage 501 is increased in cost and size.

Further, since the motors 533 and 591, the belt transmission mechanisms 532 and 592 and motor drivers are required to drive the XY stage in the X direction and Y direction, respectively, the XY stage 501 becomes more expensive.

### SUMMARY OF THE INVENTION

It is an object of the present invention to provide a simple and inexpensive XY stage capable of determining a two dimensional position using one driving source such as a motor.

According to an aspect of the present invention, there is provided an XY stage comprising a moving table, a first guide mechanism to guide the moving table in a predetermined direction, a moving body mounted to the moving table, a second guide mechanism to guide the moving body in a direction intersecting with a guiding direction of the first guide mechanism with respect to the moving table, a drive mechanism to drive the moving table in the guiding direction of the first guide mechanism, and a converting mechanism to convert motion of the moving table in the guiding direction of the first guide mechanism into motion of the moving body in a guiding direction of the second guide mechanism.

### BRIEF DESCRIPTION OF THE DRAWINGS

The above and further objects, features and advantages of the present invention will become more apparent from the following detailed description taken in conjunction with the accompanying drawings, wherein:

FIG. 1 is a plan view of the XY stage in accordance with a first embodiment of the present invention;

FIG. 2 is a perspective view of the XY stage in accordance with a second embodiment of the present invention;

FIG. 3 is a plan view of the XY stage in accordance with the second embodiment of the present invention;

FIG. 4 is a plan view of the XY stage in accordance with a third embodiment of the present invention; and

FIG. 5 is a plan view of the conventional XY stage.

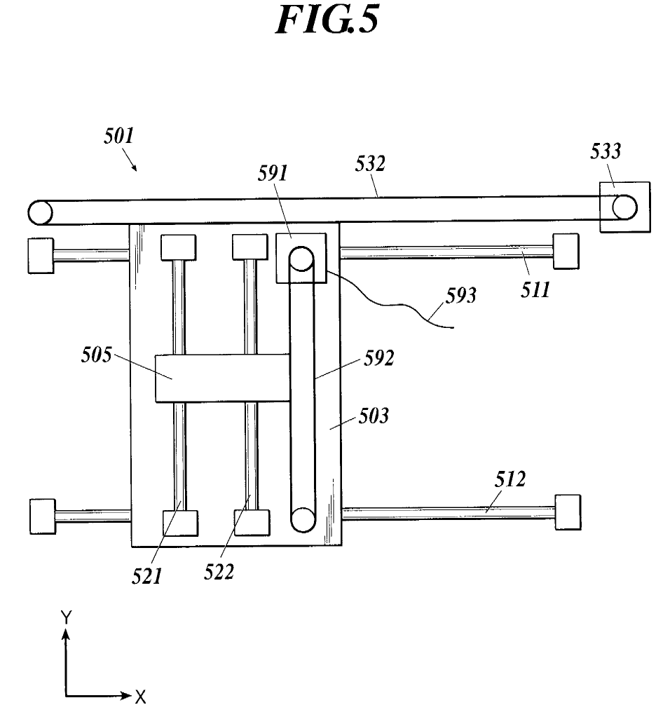

### DESCRIPTION OF THE PREFERRED EMBODIMENTS

Preferred embodiments of the present invention will be explained below with reference to the drawings. The embodiments described below include technically preferable various limitations to carry out the invention, but the scope of the invention is not limited to the embodiments and the illustrated examples.

### First Embodiment

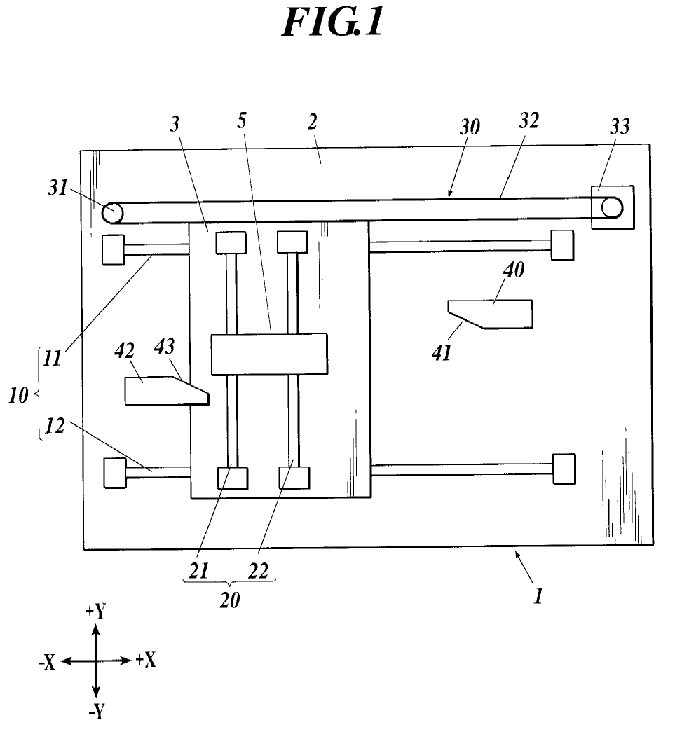

FIG. 1 is a plan view of an XY stage 1.

As shown in FIG. 1, a moving table 3 is mounted to a table 2, and the moving table 3 is straightly guided by an X-direction guide mechanism 10. The X-direction guide mechanism 10 includes two straight guide shafts 11 and 12. The guide shafts 11 and 12 are fixed in parallel to each other to an upper surface of the table 2. The guide shafts 11 and 12 pass through the moving table 3 at its thick portion via bushes, and the moving table 3 can slide with respect to the guide shafts 11 and 12. Hereinafter, a direction in which the moving table 3 is guided by the X-direction guide mechanism 10 is described as an X direction, a direction toward one end in the X direction is called a +X direction, and a direction opposite to the +X direction is called a −X direction.

The X-direction guide mechanism 10 may include straight slide rails instead of the guide shafts 11 and 12, and the moving table 3 may be guided in the X direction by the slide rails.

A moving body 5 is mounted above the moving table 3, and the moving body 5 is straightly guided by a Y direction guide mechanism 20 in a direction intersecting with the X direction at a right angle. The Y direction guide mechanism 20 includes two guide shafts 21 and 22. The guide shafts 21 and 22 intersect with the guide shafts 11 and 12 as viewed from above, and the guide shafts 21 and 22 are fixed in parallel to each other to an upper surface of the moving table 3. The guide shafts 21 and 22 pass through the moving body 5 via bushes and the moving body 5 can slide with respect to the guide shafts 21 and 22. Hereinafter, a direction in which the moving body 5 is guided by the Y-direction guide mechanism 20 is described as a Y direction, a direction toward one end in the Y direction is called a +Y direction, and a direction opposite from the +Y direction is called a −Y direction.

The Y direction guide mechanism 20 may include a slide rails, and the moving table 3 may be guided in the Y direction by the slide rails.

An upper surface of the moving body 5 is flat, and an embarkation such as a test piece and a sample is mounted on the upper surface of the moving body 5.

The moving table 3 is driven in the X direction by a drive mechanism 30. The drive mechanism 30 includes a pulley 31, a timing belt 32 and a motor 33. The pulley 31 is provided near one end of the guide shaft 11 such that the pulley 31 can rotate around its axis. The motor 33 is provided on the table 2 near the other end of the guide shaft 11. The timing belt 32 is wound around the pulley 31 and the motor 33, and a portion of the timing belt 32 is bonded to the moving table 3. The drive mechanism 30 may use a pinion rack mechanism or a ball screw transmission mechanism instead of the belt transmission mechanism.

The XY stage 1 includes a converting mechanism which converts motion of the moving table 3 in the X direction by the drive mechanism 30 into motion of the moving body 5 in the Y direction. The converting mechanism includes two converting plates 40 and 42. The converting plates 40 and 42 are disposed in a movable range of the moving body 5, and are fixed to the table 2. The converting plate 40 is disposed near the one end of the guide shaft 11 in the X direction, and the converting plate 42 is disposed on the opposite side from the converting plate 40 with respect to the moving table 3 and near the other end of the guide shaft 12 in the X direction. The converting plate 40 is formed with a first inclined surface 41 which is inclined in both the X direction and the Y direction. The converting plate 42 is also formed with a second inclined surface 43 which is inclined in both the X direction and the Y direction. The first inclined surface 41 and the second inclined surface 43 face each other.

The moving body 5 can come in contact with and separate from the first inclined surface 41 and the second inclined surface 43 by moving the moving table 3 in the X direction. The moving body 5 can be brought into a state where the moving body 5 is in contact with either one of the first inclined surface 41 and the second inclined surface 43, and into a state where the moving body 5 is away from both the first inclined surface 41 and the second inclined surface 43 by moving the moving table 3 in the X direction. In the state where the moving body 5 is in contact with the first inclined surface 41 of the converting plate 40, motion of the moving table 3 in the +X direction is converted into motion of the moving body 5 in the −Y direction by the first inclined surface 41. In the state where the moving body 5 is in contact with the second inclined surface 43 of the converting plate 42, motion of the moving table 3 in the −X direction is converted into motion of the moving body 5 in the +Y direction by the second inclined surface 43.

Next, the operation of the XY stage 1 will be explained.

If the motor 33 is operated and the moving table 3 moves in the +X direction by power of the motor 33, the moving body 5 comes in contact with the first inclined surface 41, and if the moving table 3 further moves in the +X direction, the moving body 5 is pushed by the first inclined surface 41 and is moved in the −Y direction. If the moving body 5 reaches a predetermined position in the Y direction, the motor 33 stops and the position of the moving body 5 in the Y direction is determined. If the motor 33 is operated in the opposite way and the moving table 3 moves in the −X direction, the moving body 5 moves in the X direction together with the moving table 3 while maintaining the position in the Y direction, and if the motor 33 stops, the position of the moving body 5 in the X direction and in the Y direction is determined.

If the motor 33 is operated and the moving table 3 is moved in the −X direction by the power of the motor 33, the moving body 5 comes in contact with the second inclined surface 43, and if the moving table 3 further moves in the −X direction, the moving body 5 is pushed by the second inclined surface 43 and is moved in the +Y direction. If the moving body 5 reaches a predetermined position in the Y direction, the motor 33 stops and the position of the moving body 5 in the Y direction is determined. If the motor 33 is operated in the opposite way and the moving table 3 moves in the +X direction, the moving body 5 moves in the +X direction together with the moving table 3 while maintaining the position in the Y direction, and if the motor 33 stops, the position of the moving body 5 in the X direction and in the Y direction is determined.

As described above, according to the embodiment, the motion of the moving table 3 in the +X direction is converted into the motion of the moving body 5 in the −Y direction by the first inclined surface 41, and the motion of the moving table 3 in the −X direction is converted into the motion of the moving body 5 in the +Y direction by the second inclined surface 43. Therefore, a two dimensional position of the moving body 5 can be determined without providing the XY stage 1 with another power source for the moving body 5 only. Since the motor 33 of the drive mechanism 30 is only the power source, a simple and inexpensive XY stage 1 can be provided.

Since no motor is mounted on the moving table 3, and a cable for the motor is not required, the XY stage 1 can be provided in a simple manner inexpensively.

Since no motor is mounted on the moving table 3, output of the motor 33 can be reduced, and the obtaining cost of the motor 33 can be reduced.

Although the opposed two corners of the moving body 5 are in abutment against the first inclined surface 41 and the second inclined surface 43 in the embodiment, the moving body 5 may be provided with pins which are to abut against the first inclined surface 41 and the second inclined surface 43.

### Second Embodiment

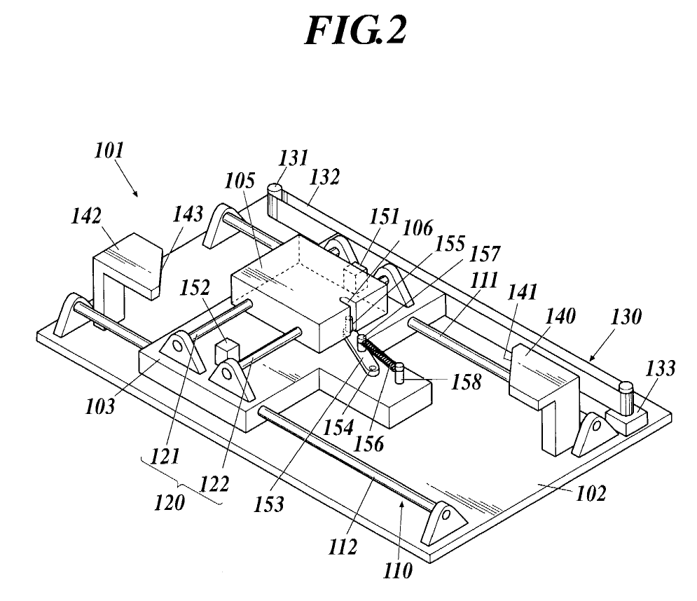

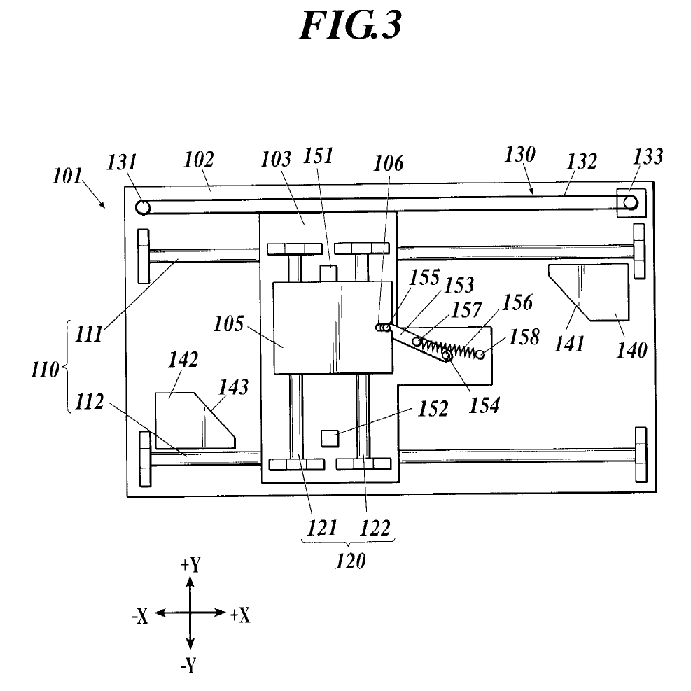

An XY stage 101 according to a second embodiment will be explained using a perspective view of FIG. 2 and a plan view of FIG. 3. Constituent members of the XY stage 101 corresponding to those of the XY stage 1 of the first embodiment are designated with common last two-digit numbers.

As shown in FIG. 2 and FIG. 3, a moving table 103 is guided above a table 102 by an X direction guide mechanism 110 in the X direction, and a moving body 105 is guided above a moving table 103 by a Y direction guide mechanism 120 in the Y direction. The moving table 103 is driven by a drive mechanism 130 in the X direction. Motion of the moving table 103 in the +X direction is converted into motion of the moving body 105 in the −Y direction by a first inclined surface 141, and motion of the moving table 103 in the −X direction is converted into motion of the moving body 105 in the +Y direction by a second inclined surface 143. Since the X direction guide mechanism 110, the Y direction guide mechanism 120, the drive mechanism 130 and the converting plates 140 and 142 are provided in the same manner as those of the first embodiment, detailed explanation thereof will be omitted.

Two stoppers 151 and 152 are fixed on the moving table 103. The stoppers 51and 152 are disposed on opposite sides in the Y direction with respect to the moving body 105, the one stopper 151 is disposed near one end of the guide shafts 121 and 122, and the other stopper 152 is disposed near the other end of the guide shafts 121 and 122. The moving body 105 can come in contact with and separate from the stoppers 151 and 152 by moving in the Y direction.

An arm 153 and a tensile spring 156 are mounted on the moving table 103. A base end of the arm 153 is connected to the moving table 103 at a position away from the moving body 105 in the +X direction, and the arm 153 can rotate around a hinge pin 154 at the base end of the arm 153. The hinge pin 154 intersects with both the X direction and the Y direction at right angles. The arm 153 is provided at its tip end with a slide pin 155. The moving body 105 is formed with a notch 106 elongated in a direction parallel to guide shafts 111 and 112, and the slide pin 155 is slidably inserted in the notch 106. If the slide pin 155 is inserted into the notch 106, the slide pin 155 is allowed to move in the X direction with respect to the moving body 105, and the slide pin 155 is further allowed to rotate around a post intersecting with the X direction and Y direction at right angles with respect to the moving body 105.

One end of the tensile spring 156 is connected to the arm 153 at an intermediate portion of the arm 153 between its tip end and its base end. The other end of the tensile spring 156 is connected to the moving table 103 at a location away from the moving body 105 in the +X direction. One end of the tensile spring 156 can rotate around a post 157 intersecting with the X direction and the Y direction at right angles with respect to the arm 153. The other end of the tensile spring 156 can rotate around a post 158 intersecting with the X direction and the Y direction at right angles with respect to the moving table 103. The tensile spring 156 pulls the arm 153 toward the post 158 by a restoring force of the tensile spring 156.

Next, the operation of the XY stage 101 will be explained.

As shown in FIG. 3, moment acts on the arm 153 by the restoring force of the tensile spring 156, the moving body 105 abuts against the stopper 151 and the arm 153 and the moving body 105 are stopped. From this state, a motor 133 is operated, and if the moving table 103 is moved in the +X direction by a power of the motor 133, the moving body 105 comes in contact with the first inclined surface 141, the moving body 105 is pushed by the first inclined surface 141 and is separated from the stopper 151, and the moving body 105 is moved in the −Y direction. As the moving body 105 is moved in the −Y direction, the arm 153 rotates around the hinge pin 154, and if the moving body 105 moves further in the −Y direction from a state where the slide pin 155, the post 157, the hinge pin 154 and the post 158 are aligned in a straight line, the moving body 105 is moved in the −Y direction by the restoring force of the tensile spring 156, the moving body 105 is separated from the first inclined surface 141, and the moving body 105 abuts against the stopper 152 and stops.

If the motor 133 is operated in the opposite way and the moving table 103 moves in the −X direction by the power of the motor 133, the moving body 105 comes in contact with the second inclined surface 143, the moving body 105 is pushed by the second inclined surface 143 and separated from the stopper 152, and the moving body 105 is moved in the +Y direction. As the moving body 105 is moved in the +Y direction, the arm 153 rotates around the hinge pin 154, and if the moving body 105 moves in the +Y direction from a state where the slide pin 155, the post 157, the hinge pin 154 and the post 158 are aligned in a straight line, the moving body 105 is moved in the +Y direction by the restoring force of the tensile spring 156, the moving body 105 is separated from the second inclined surface 143, and the moving body 105 abuts against the stopper 151 and stops.

As described above, the position of the moving body 105 in the Y direction is determined in the state where the moving body 105 abuts against the stopper 151 or the state where the moving body 105 abuts against the stopper 152. If the moving table 103 is moved in the +X direction or −X direction by the motor 133 in a state where the position of the moving body 105 in the Y direction is determined, the position of the moving body 105 in the X direction is determined.

According to this embodiment, the two dimensional position of the moving body 105 can be determined only by the motor 133 of the drive mechanism 130 without providing the XY stage 101 with a power source only for the moving body 105. Thus, a simple and inexpensive XY stage 101 can be provided.

Since the moving body 105 stops in a state where the moving body 105 is abutted against the stopper 151 or 152 by the restoring force of the tensile spring 156, even if the XY stage 101 vibrates, the moving body 105 is not deviated in position. Thus, the position of the moving body 105 can precisely be determined.

### Third Embodiment

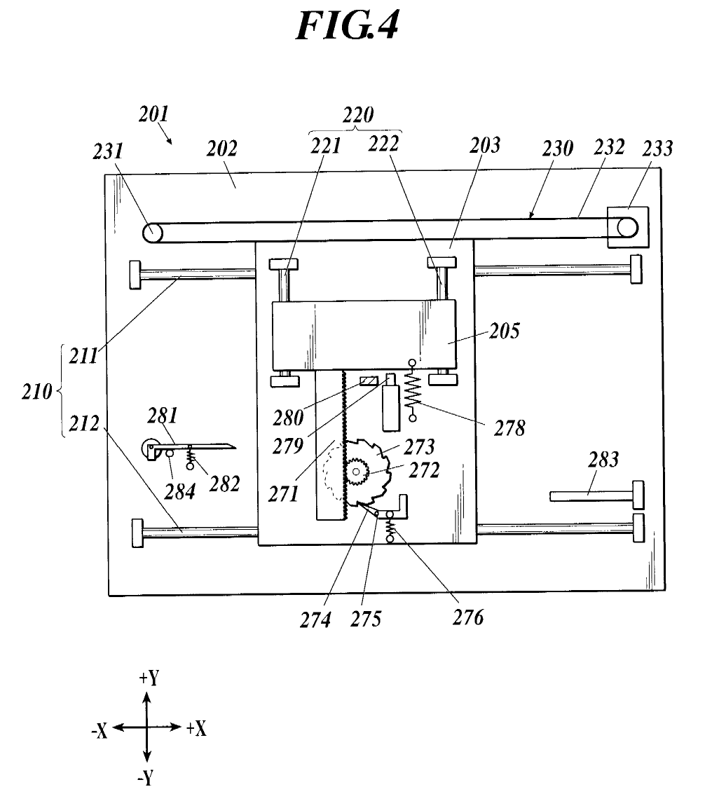

An XY stage 201 of a third embodiment will be explained using a plan view of FIG. 4. Constituent members of the XY stage 201 corresponding to those of the XY stage 1 of the first embodiment are designated with common last two-digit numbers.

As shown in FIG. 4, a moving table 203 is guided above a table 202 by an X direction guide mechanism 210 in the X direction, a moving body 205 is guided above a moving table 203 by a Y direction guide mechanism 220 in the Y direction, and the moving table 203 is driven by a drive mechanism 230 in the X direction. Since the X direction guide mechanism 210, the Y direction guide mechanism 220 and the drive mechanism 230 are provided in the same manner as that of the first embodiment, detailed explanation thereof will be omitted.

The XY stage 201 is not provided with a converting plate which converts motion of the moving table 203 in the X direction into motion of the moving body 205 in the Y direction. Instead of the converting plate, a converting mechanism described as follows converts the motion of the moving table 203 in the X direction into the motion of the moving body 205 in the Y direction.

That is, as shown in FIG. 4, one end of a tensile spring 278 is connected to the moving body 205, and the other end of the tensile spring 278 is connected to the moving table 203. The moving body 205 is biased in the −Y direction by a restoring force of the tensile spring 278.

A rack 271 is mounted to the moving body 205. Teeth of the rack 271 are arranged in parallel to guide shafts 221 and 222, and a pinion 272 meshes with the rack 271. The ratchet wheel 273 is fixed to the pinion 272, and the ratchet wheel 273 and the pinion 272 are coaxial with each other. The ratchet wheel 273 and the pinion 272 are mounted to the moving table 203 such that an axis of the ratchet wheel 273 and the pinion 272 intersect with the X direction and the Y direction at right angles, and the pinion 272 and the ratchet wheel 273 can rotate around the axis thereof with respect to the moving table 203.

A locking pawl 274 is disposed near the ratchet wheel 273. The locking pawl 274 is mounted to the moving table 203 such that the locking pawl 274 can rotate around a shaft 275 which intersects with the X direction and the Y direction. One end of a spring 276 is connected to the locking pawl 274, the other end of the spring 276 is connected to the moving table 203, and the locking pawl 274 meshes with the teeth of the ratchet wheel 273 by a restoring force of the spring 276. If the locking pawl 274 meshes with the teeth of the ratchet wheel 273, this prevents the ratchet wheel 273 from rotating in one direction, and this prevents the moving body 205 from being moved by the tensile spring 278 in the −Y direction.

A sending pawl 281 is disposed at a location away from the ratchet wheel 273 in the −X direction. A releasing rod 283 is disposed on the opposite side to the sending pawl 281 with respect to the ratchet wheel 273. A base end of the sending pawl 281 is mounted on the table 202 such that the sending pawl 281 can rotate around a post intersecting with the X direction and the Y direction at right angles. One end of a spring 282 is connected to the sending pawl 281, the other end of the spring 282 is connected to the table 202, and the sending pawl 281 is pulled in the clockwise direction in FIG. 4 by the spring 282. A stopper 284 is disposed at a location further turned in the clockwise direction from the sending pawl 281. If the sending pawl 281 abuts against the stopper 284, a state in which a tip end of the sending pawl 281 is oriented to the outer periphery of the ratchet wheel 273 is maintained. The releasing rod 283 is fixed to the table 202, and the tip end of the releasing rod 283 is oriented to the locking pawl 274.

The XY stage 201 also includes a stopper 280 and a dumper 279 in addition to the converting mechanism having the above-described structure. The stopper 280 and the dumper 279 are disposed in a pulling direction (−Y direction) of the tensile spring 278 with respect to the moving body 205. A tip end of the dumper 279 is located slightly further in the +Y direction compared to the stopper 280. The stopper 280 and the dumper 279 are fixed to the moving table 203.

Next, the operation of the XY stage 201 will be explained.

If a motor 233 is operated, the moving table 203 moves in the −X direction, and the ratchet wheel 273 approaches the sending pawl 281. If the moving table 203 further moves in the −X direction, the sending pawl 281 meshes with the teeth of the ratchet wheel 273, and the ratchet wheel 273 is rotated by one tooth by means of the sending pawl 281. By the rotation of the ratchet wheel 273, the moving body 205 moves in the +Y direction against the tensile spring 278. After the ratchet wheel 273 is rotated by one tooth, the motor 233 is operated in the opposite way, and the ratchet wheel 273 is separated from the sending pawl 281 in the +X direction.

Each time the above-described operation is carried out, the ratchet wheel 273 is moved in the +Y direction by one tooth. After the intermittent movement of the moving body 105 in the +Y direction is completed, if the moving table 203 is moved in the +X direction or the −X direction by the motor 233 in a state where the position of the moving body 205 in the Y direction is determined, the position of the moving body 205 in the X direction is determined.

If the motor 233 is operated and the moving table 203 is moved in the +X direction and the locking pawl 274 is pushed by the releasing rod 283 and is rotated, the meshed state between the locking pawl 274 and the ratchet wheel 273 is released. If the meshed state is released, the moving body 205 is moved in the −Y direction by the restoring force of the tensile spring 278, and the moving body 205 abuts against the stopper 280 and stops. Before the moving body 205 abuts against the stopper 280, the moving body 205 abuts against the dumper 279, and an impact force is absorbed by the dumper 279. If the motor 233 is operated and the moving table 203 is moved in the −X direction, the locking pawl 274 is separated from the releasing rod 283 in the −X direction, and the locking pawl 274 meshes with the tooth of the ratchet wheel 273.

As described above, according to the embodiment, the moving body 205 can be moved in the +Y direction only by moving the moving table 203 in the −X direction by the motor 233 of the drive mechanism 230, and the moving body 205 can be moved in the −Y direction and can be returned to its original position only by moving the moving table 203 in the +X direction without providing the XY stage 201 with a power source only for the moving body 205. Since the two dimensional position of the moving body 205 can be determined only by the motor 233, it is possible to provide a simple and inexpensive XY stage 201.

Since the ratchet wheel 273 is used, the position of the moving body 205 can be determined in a step-by-step manner.

Since the biasing force of the tensile spring 278 in the −Y direction is received by the meshed state between the locking pawl 274 and the ratchet wheel 273, even if the XY stage 201 vibrates, the moving body 205 is not deviated in position. Therefore, the position of the moving body 205 can precisely be determined.

According to an aspect of the embodiments of the present invention, there is provided an XY stage comprising a moving table, a first guide mechanism to guide the moving table in a predetermined direction, a moving body mounted to the moving table, a second guide mechanism to guide the moving body in a direction intersecting with a guiding direction of the first guide mechanism with respect to the moving table, a drive mechanism to drive the moving table in the guiding direction of the first guide mechanism, and a converting mechanism to convert motion of the moving table in the guiding direction of the first guide mechanism into motion of the moving body in a guiding direction of the second guide mechanism.

If the moving table is driven by the drive mechanism, the moving table moves in the guiding direction of the first guide mechanism, and the motion of the moving table is converted into the motion of the moving body by the converting mechanism so that the moving body moves in the guiding direction of the second guide mechanism. Thus, the position of the moving table in the guiding direction of the first guide mechanism can be determined by the drive mechanism, and the position of the moving body in the guiding direction of the second guide mechanism can also be determined by the drive mechanism. Hence, the two dimensional position of the moving body can be determined by the one drive mechanism. Thus, the constituent elements of the XY stage can be simplified, and the producing cost of the XY stage can be reduced.

Preferably, the converting mechanism includes a first inclined surface which is inclined with respect to the guiding direction of the first guide mechanism and the guiding direction of the second guide mechanism.

Since the first inclined surface is inclined with respect to the guiding direction of the first guide mechanism and the guiding direction of the second guide mechanism, if the moving table is driven by the drive mechanism in a state where the moving body abuts against the first inclined surface, the moving body is pushed by the first inclined surface, and the moving body moves in the guiding direction of the second guide mechanism. Therefore, the two dimensional position of the moving body can be determined by the one drive mechanism, and a simple and inexpensive XY stage can be provided.

Preferably, the converting mechanism includes a second inclined surface which is inclined with respect to the guiding direction of the first guide mechanism and the guiding direction of the second guide mechanism, and which is opposed to the first inclined surface.

Since the second inclined surface is opposed to the first inclined surface, if the moving table is driven by the drive mechanism in a state where the moving body abuts against the second inclined surface, the moving body moves in the opposite direction from the case of the first inclined surface. Therefore, even if the moving table moves in any one of the opposite ways of the guiding direction of the first guide mechanism, the two dimensional position of the moving body can be determined by the one drive mechanism, and a simple and inexpensive XY stage can be provided.

Preferably, the moving table is driven by the drive mechanism, which drive allows the moving body to come in contact with and to separate from the first inclined surface and the second inclined surface.

Since the moving body can come in contact with and separate from the first inclined surface and the second inclined surface, if the moving table is driven by the drive mechanism, the moving body can move in the guiding direction of the second guide mechanism in a state where the moving body comes in contact with the first inclined surface or the second inclined surface. In a state where the moving body is not in contact with any one of the first inclined surface and second inclined surface, the moving table is moved by the drive mechanism in a state where the moving body maintains a position with respect to the moving table. Thus, the two dimensional position of the moving body can arbitrarily be determined.

Preferably, the XY stage further comprises an arm which is connected to the moving table at a location away from the moving body in the guiding direction of the first guide mechanism, and which can rotate around a connecting portion between the arm and the moving table, a slider which is attached to the arm, the slider being able to slide in the guiding direction of the first guide mechanism with respect to the moving body, and being coupled to the moving body, and a pulling member which is connected to the arm, which is connected to the moving table at a location separated in the guiding direction of the first guide mechanism further from the moving body than a coupling portion between the arm and the moving table, and which pulls the arm toward the coupling portion.

Preferably, the XY stage further comprises stoppers which are respectively disposed on both sides of the second guide mechanism in the guiding direction with respect to the moving body and which are fixed to the moving table.

If the arm is pulled by the pulling member, the moving body is moved in one of the opposite ways of the guiding direction of the second guide mechanism, and the moving body abuts one of the stoppers and stops. In a state where the moving body is in contact with the first inclined surface or the second inclined surface, if the moving table is driven by the drive mechanism, the moving body is moved in the guiding direction of the second guide mechanism, the arm is pulled by the pulling member, and the moving body abuts against the other stopper and stops. In this manner, the position of the moving body in the guiding direction of the second guide mechanism is determined in the state where the moving body abuts against one of the stoppers.

Preferably, the converting mechanism includes a ratchet wheel rotatably mounted to the moving table, a pinion attached to the ratchet wheel coaxially with the ratchet wheel, a rack which is attached to the moving body, which has teeth arranged in the guiding direction of the second guide mechanism, and which meshes with the pinion, and a sending pawl which is disposed at a location away from the ratchet wheel in the guiding direction of the first guide mechanism, and which meshes with the ratchet wheel to rotate the ratchet wheel.

If the moving table is sent toward the sending pawl by the drive mechanism, the sending pawl meshes with the ratchet wheel and the ratchet wheel is rotated by the sending pawl. The rotation of the ratchet wheel is transmitted to the moving body through the pinion and the rack, and the moving body moves in the guiding direction of the second guide mechanism. In this manner, the motion of the moving table in the guiding direction of the first guide mechanism is converted into the motion of the moving body in the guiding direction of the second guide mechanism. Therefore, the two dimensional position of the moving body can be determined by the one drive mechanism, and a simple and inexpensive XY stage can be provided.

Preferably, the converting mechanism includes a biasing member to bias the moving body in one direction of the guiding direction of the second guide mechanism, a locking pawl which meshes with the ratchet wheel to stop rotation of the ratchet wheel by a biasing force of the biasing member, and which can release the mesh of the locking pawl with the ratchet wheel, and a releasing member which is disposed on the opposite side from the sending pawl with respect to the ratchet wheel, and which abuts against the locking pawl to release the mesh of the locking pawl.

If the moving table is sent toward the releasing member by the drive mechanism, the releasing member abuts against the locking pawl and the mesh of the locking pawl and the ratchet wheel is released, and the ratchet wheel is brought into a rotatable state. The moving body is moved by a biasing force of the biasing member, and the moving body which was sent by the sending pawl returns to its original position.

Preferably, the XY stage further comprises a stopper which is disposed on a side of the biasing direction of the biasing member with respect to the moving body, and which is fixed to the moving table.

If the moving body abuts against the stopper, the biasing force of the biasing member which acts on the moving body is received.

The entire disclosure of Japanese Patent Application No. 2006-139084 filed on May 18, 2006 including specification, claims, drawings and abstract are incorporated herein by reference in its entirety.

Although various exemplary embodiments have been shown and described, the invention is not limited to the embodiments shown. Therefore the scope of the invention is intended to be limited solely by the scope of the claims that follow.

What is claimed is:

1. An XY stage, comprising:
a moving table;
a first guide mechanism to guide the moving table in a predetermined direction;
a moving body mounted to the moving table;
a second guide mechanism to guide the moving body in a direction intersecting with a guiding direction of the first guide mechanism with respect to the moving table;
a drive mechanism to drive the moving table in the guiding direction of the first guide mechanism; and
a converting mechanism to convert motion of the moving table in the guiding direction of the first guide mechanism into motion of the moving body in a guiding direction of the second guide mechanism.

2. The XY stage according to claim 1, wherein the converting mechanism includes a first inclined surface which is inclined with respect to the guiding direction of the first guide mechanism and the guiding direction of the second guide mechanism.

3. The XY stage according to claim 2, wherein the converting mechanism includes a second inclined surface which is inclined with respect to the guiding direction of the first guide mechanism and the guiding direction of the second guide mechanism, and which is opposed to the first inclined surface.

4. The XY stage according to claim 3, wherein the moving table is driven by the drive mechanism, which drive allows the moving body to come in contact with and to separate from the first inclined surface and the second inclined surface.

5. The XY stage according to claim 2, further comprising:
an arm which is connected to the moving table at a location away from the moving body in the guiding direction of the first guide mechanism, and which can rotate around a connecting portion between the arm and the moving table;
a slider which is attached to the arm, the slider being able to slide in the guiding direction of the first guide mechanism with respect to the moving body, and being coupled to the moving body; and
a pulling member which is connected to the arm, which is connected to the moving table at a location separated in the guiding direction of the first guide mechanism further from the moving body than a coupling portion between the arm and the moving table, and which pulls the arm toward the coupling portion.

6. The XY stage according to claim 5, further comprising stoppers which are respectively disposed on both sides of the second guide mechanism in the guiding direction with respect to the moving body and which are fixed to the moving table.

7. The XY stage according to claim 1, wherein the converting mechanism includes
a ratchet wheel rotatably mounted to the moving table,
a pinion attached to the ratchet wheel coaxially with the ratchet wheel,
a rack which is attached to the moving body, which has teeth arranged in the guiding direction of the second guide mechanism, and which meshes with the pinion, and
a sending pawl which is disposed at a location away from the ratchet wheel in the guiding direction of the first guide mechanism, and which meshes with the ratchet wheel to rotate the ratchet wheel.

8. The XY stage according to claim 7, wherein the converting mechanism includes
a biasing member to bias the moving body in one direction of the guiding direction of the second guide mechanism,
a locking pawl which meshes with the ratchet wheel to stop rotation of the ratchet wheel by a biasing force of the biasing member, and which can release the mesh of the locking pawl with the ratchet wheel, and
a releasing member which is disposed on the opposite side from the sending pawl with respect to the ratchet wheel, and which abuts against the locking pawl to release the mesh of the locking pawl.

9. The XY stage according to claim 8, further comprising a stopper which is disposed on a side of the biasing direction of the biasing member with respect to the moving body, and which is fixed to the moving table.
